(19) United States
(12) Patent Application Publication
(10) Pub. No.: US 2013/0327695 A1
(43) Pub. Date: Dec. 12, 2013

(54) Magnet Configurations For Improved Separations Of Magnetic And Non-Magnetic Materials

(71) Applicant: Massachusetts Institute of Technology, Cambridge, MA (US)

(72) Inventors: Markus Zahn, Cambridge, MA (US); T. Alan Hatton, Sudbury, MA (US); Shahriar Rohinton Khushrushahi, Cambridge, MA (US)

(73) Assignee: Massachusetts Institute of Technology, Cambridge, MA (US)

(21) Appl. No.: 13/911,171

(22) Filed: Jun. 6, 2013

Related U.S. Application Data
(60) Provisional application No. 61/657,274, filed on Jun. 8, 2012.

(51) Int. Cl. B03C 1/02

(52) U.S. Cl. CPC B03C 1/02
USPC 210/222

(57) ABSTRACT

Magnet configuration. The configuration includes a magnet holder and at least one elongate magnet extending from the magnet holder so that less than one half of the magnet length extends from the holder, whereby a magnetic fluid adjacent the elongate magnet is attracted toward a top edge of the elongate magnet for subsequent removal.

This application claims priority to provisional application Ser. No. 61,657,274 filed on Jun. 8, 2012, the contents of which are incorporated herein by reference in their entirety.

### BACKGROUND OF THE INVENTION

This invention relates to magnet configurations to improve separations of magnetic and non-magnetic materials, using non-uniform magnetic fields generated by the edges of permanent magnets or electromagnets.

Magnetic separation of magnetic liquid phase/particles from non-magnetic liquid phase/particles is needed for such applications as cleaning up oil spills by separating oil and water liquid phases, or separating magnetic materials from non-magnetic materials in biomedical and microfluidic applications.

Most magnetic separation techniques work on a single principle of applying a magnetic field in a single flow channel to direct the magnetic phase/particles to one side of the channel for separation farther along the flow channel. Inlet velocity/pressure, volume fraction and viscosities of either phase, magnetic strength of the magnetic phase and applied field are some of the parameters that need to be known beforehand, and control of these parameters is necessary for efficient separation. In addition, a varying concentration of either the magnetic or non-magnetic components in a mixture adds to the difficulty of separation and can result in contamination of the separated components.

Separation is driven by the Kelvin magnetization force that requires a spatial non-uniformity in a magnetic field. Although non-uniform magnetic fields can be generated, such fields are also inherent to the edges of magnetizable/magnetized permanent magnets. An object of the present invention is to provide embodiments generating non-uniform magnetic fields produced by the edges of permanent magnets for the magnetic separation of a variable magnetic volume traction of a mixture of non-magnetic and magnetic liquid phases/particles. Another object of the invention is the use of a one-sided magnetic flux configuration to increase the efficiency of separations.

### SUMMARY OF THE INVENTION

The magnet configuration of the invention includes a magnet holder and at least one elongate magnet extending from the magnet holder so that less than one half of the magnet length extends from the holder. A magnetic fluid adjacent the elongate magnet is attracted toward a top edge of the elongate magnet for subsequent removal. It is preferred that a covering be placed over the magnet portion extending from the magnet holder. It is also preferred that the at least one elongate magnet is an array of a plurality of elongate magnets that may be cylindrical. In yet another embodiment, the elongate magnets are curved. In one such embodiment, four curved magnets have ends facing one another.

Another embodiment of the invention includes a Halbach array of magnets providing a one-sided magnetic flux and located proximate the at least one elongate magnet. It is preferred that the Halbach array comprise a plurality of cubic-shaped permanent magnets. It is also preferred that the magnet holder rest in a vessel for receiving a fluid for separation.

### BRIEF DESCRIPTION OF THE DRAWING

FIG. 1 is a perspective view of a magnet holder with an array of magnets extending from a surface thereof according to an embodiment of the invention.

FIG. 2 is a cross-sectional view of the magnet holder of FIG. 1 inserted into a test chamber or vessel.

FIG. 3 is a cross-sectional view of an embodiment of the invention showing a droplet of magnetic fluid elevated to the level of the top of one of the permanent magnets.

FIG. 4 is a perspective view of an embodiment of the invention showing magnetic fluid attracted to two of the magnets.

FIG. 5 is a schematic, perspective view of an embodiment of the invention including carved cylindrical magnets to improve separation efficiency.

FIG. 6 is a schematic illustration of the magnetic field arrangement in a Halbach array.

FIG. 7 is a perspective view of cubic magnets forming a Halbach array.

FIGS. 8A, B and C are perspective views of a polycarbonate casing of an embodiment of the invention to form a Halbach array.

FIG. 9 is a perspective view of an experiment showing magnetic fluid attached to a Halbach array.

### DESCRIPTION OF THE PREFERRED EMBODIMENT

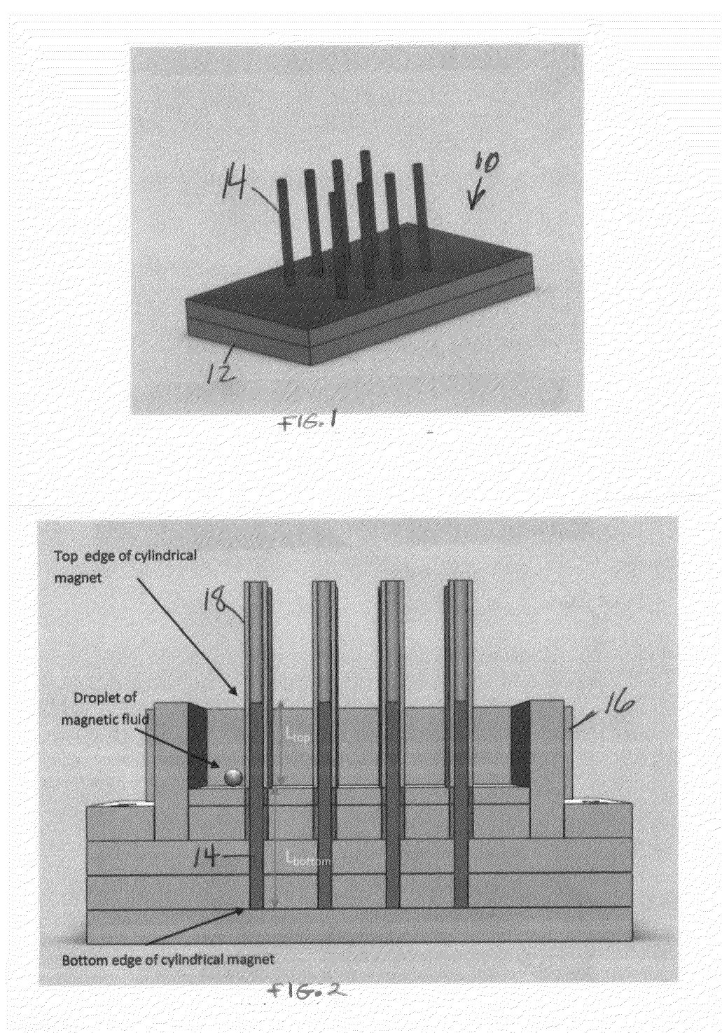

With reference first to FIG. 1 the magnetic configuration 10 includes a magnet holder 12 into which are press fit cylindrical magnets 14. It should be noted that the elongate magnets 14 may have any convenient shape but cylindrical magnets have been used to demonstrate the concept disclosed in the present application.

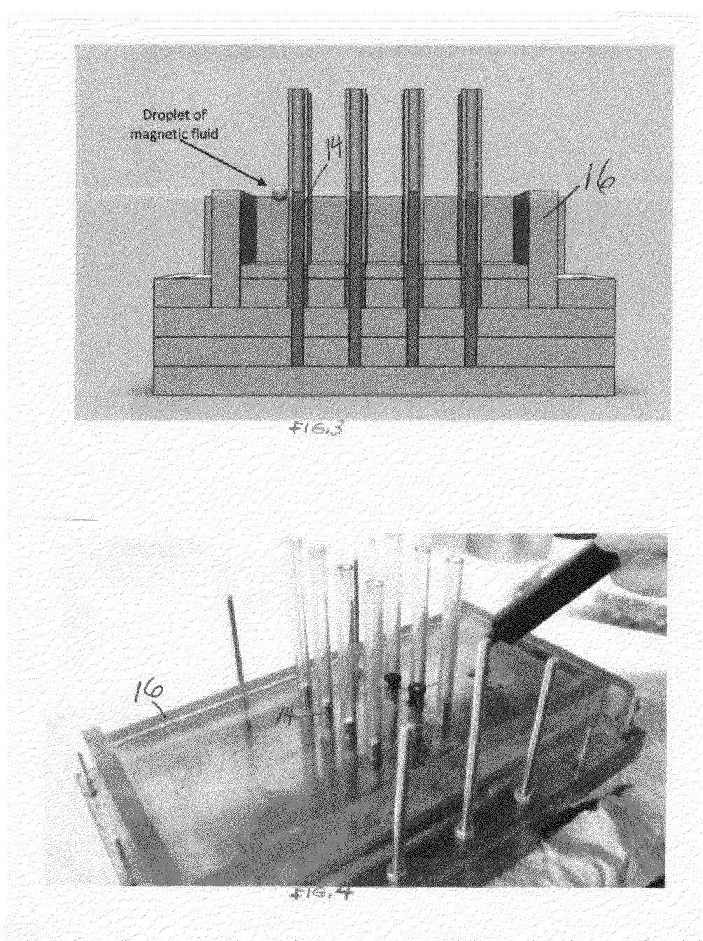

In order to keep magnetized fluid away from the magnets 14 themselves, it is preferred that they be protected by inserting the magnet holder 12 and magnets 14 into a vessel 16 that includes plastic tubes 18 that fit over the magnets 14. As shown in FIG. 2, it is important that the length of a magnet 14 above a surface in the vessel 16, known as Lₜₒₚ, be shorter than the portion at the bottom referred to as L_{bottom}. It is important that Lₜₒₚ is less than L_{bottom} so that a magnetic droplet gets attracted to a top edge of a cylindrical magnet 14 and not to a bottom edge. Otherwise, if a droplet is attracted to the bottom edge of the cylindrical magnet it would just stay at the bottom of the vessel 16 and not be separated from the non-magnetic phase. As shown in FIG. 3, a droplet of magnetic fluid will be attracted to the top edge of the magnet 14.

With reference now to FIG. 4, an experiment will be described. Water is added to the vessel 16 followed by an oil-based magnetic fluid such as Ferrotec EFH1 ferrofluid. As can be seen in FIG. 4 the magnets 14 attract the magnetic fluid and fluid collects at the top magnet edge where the magnetic force is the strongest thereby pulling the magnetic fluid above the non-magnetic water phase separating the two phases. The magnetic phase could then be collected using suction pressure or by other means such as a skimmer, etc.

Another embodiment of the invention is illustrated in FIG. 5. In this embodiment, four curved cylindrical magnets 14 are arranged to meet near a central point to allow for collected magnetic fluid at its edges. The fluid subsequently can easily be removed.

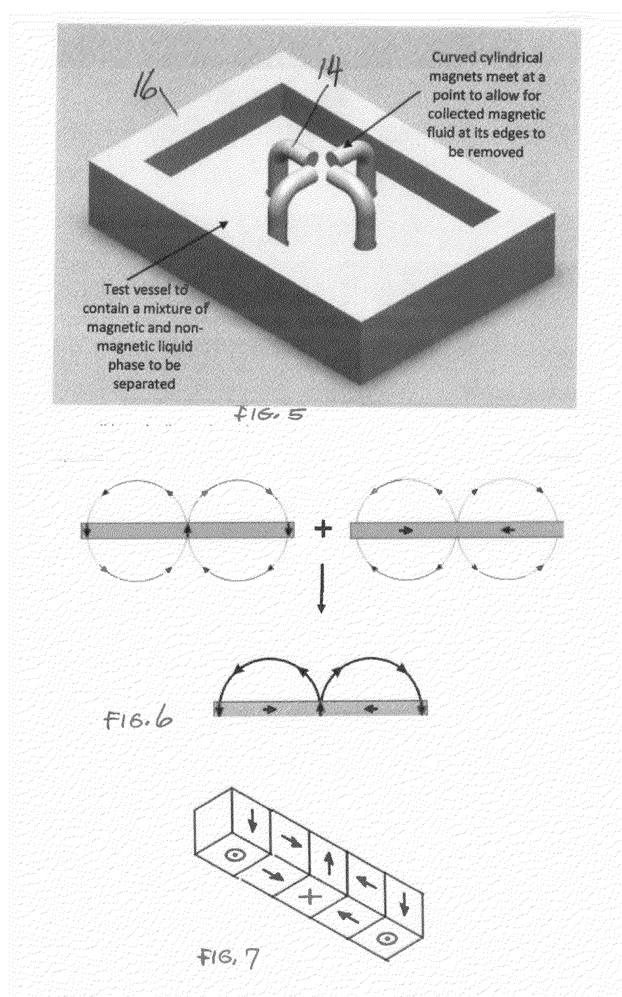

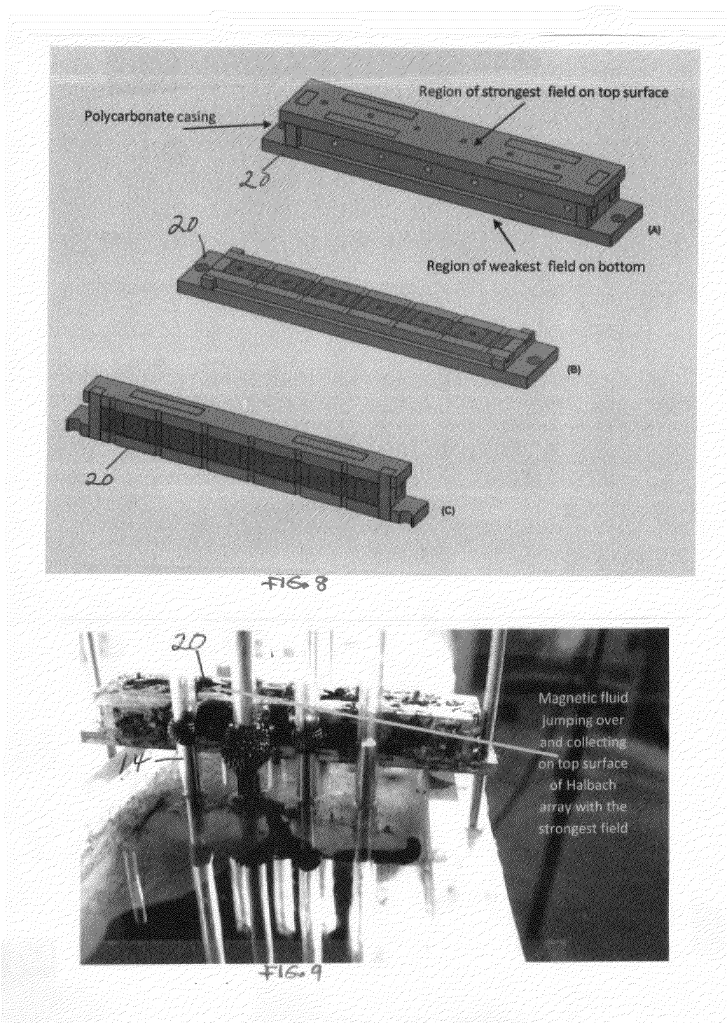

Another embodiment of the invention will be described in conjunction with FIGS. 6, 7 and 8. Those of ordinary skill in the art will appreciate that a Halbach array is a special arrangement of permanent magnets that cancel the magnetic field below one plane and increase the magnetic field above an opposite plane creating a one-sided magnetic flux. FIG. 6 shows that a Halbach array may be constructed using two vertically oriented magnets (top left) and two horizontally oriented magnets (top right) such that the magnetic fields add on the bottom of the magnet and cancel above it. In these figures, the arrow represents the orientation of the magnetic north and south pole with the arrowhead denoting the magnetic north pole. FIG. 7 shows a suitable configuration forming a Halbach array. This array uses cubic magnets resulting in a one-sided magnetic flux. The arrowhead (and the circle) represents the magnetic north pole orientation while the cross represents the magnetic south pole orientation. With respect to FIGS. 8A, B and C, a polycarbonate casing 20 holds magnets forming the Halbach array. The individual magnets are held together with screws that pass through the magnets.

In another embodiment of the invention, the Halbach array in the casing 20 is placed adjacent to the cylindrical magnets 14 as shown in FIG. 9. As with the earlier embodiment, water and a magnetic ferrofluid were placed in a vessel. As can be seen in FIG. 9, the magnetizable ferrofluid was attracted to the top of the magnets 14 and then jumped across onto the Halbach array 20 from which it can easily be recovered through suction or other means. The Halbach array is an important embodiment because the ferrofluid will collect only on one side thereby facilitating a subsequent collection.

It is recognized that modifications and variations of the present invention will be apparent to those of ordinary skill In the art and it is intended that all such modifications and variations be included within the scope of the appended claims.

What is claimed is:

1. Magnet configuration comprising:
a magnet holder; and
at least one elongate magnet extending from the magnet holder so that less than one-half of the magnet length extends from the holder;
whereby magnetic fluid adjacent the elongate magnet is attracted toward a top edge of the elongate magnet for subsequent removal.

2. The magnet configuration of claim 1 further including a covering over the magnet portion extending from the magnet holder.

3. The magnet configuration of claim 1 wherein the at least one elongate magnet is an array of a plurality of elongate magnets.

4. The magnet configuration of claim 1 wherein the elongate magnets are curved.

5. The magnet of configuration of claim 4 wherein there are four curved magnets with ends facing one another.

6. The magnet configuration of claim 1 further including a Halbach array of magnets having one-sided magnetic flux located proximate the at least one elongate magnet.

7. The magnet configuration of claim 6 wherein the Halbach array comprises a plurality of cubic-shaped permanent magnets.

8. The magnetic configuration of claim 1 wherein the magnet holder rests in a vessel for receiving a fluid for separation.
